(19) United States
(12) Patent Application Publication
(10) Pub. No.: US 2014/0340291 A1
(43) Pub. Date: Nov. 20, 2014

(54) Chamfered Circuit and Control Method Thereof

(71) Applicant: Shenzhen China Star Optoelectronics Technology Co., Ltd., Shenzhen, Guangdong (CN)

(72) Inventor: Nianmao Wang, Shenzhen City (CN)

(21) Appl. No.: 13/985,624

(22) PCT Filed: Jun. 27, 2013
(86) PCT No.: PCT/CN2013/078149

§ 371 Date: Aug. 15, 2013

(30) Foreign Application Priority Data
May 14, 2013 (CN) 201310177289X

(51) Int. Cl. G09G 3/36

(52) U.S. Cl. CPC G09G 3/3696
USPC 345/87

(57) ABSTRACT

The present invention provides a chamfered circuit and a control method thereof. The chamfered circuit comprises a direct-current voltage input terminal, a chamfered voltage output terminal, a first switching circuit, a second switching circuit, a switching circuit, a first discharge circuit and a second discharge circuit, wherein, the switching circuit selectively connects the second switching circuit to the first discharge circuit or the second discharge circuit under the control of a third timing signal in order to form a first chamfered voltage with a first discharge slope or a second chamfered voltage with a second discharge slope at the chamfered voltage output terminal. The first discharge slop is different from the second discharge slope. The present invention can eliminate the uneven brightness phenomenon on the vertical direction of the display screen, improving the display quality of the liquid crystal display device.

### BACKGROUND OF THE INVENTION

1. Field of the Invention

The present invention relates to the field of display driving techniques, and in particular to a chamfered circuit and a control method thereof.

2. The Related Arts

At present, the structure of the thin film transistor-liquid crystal display (TFT-LCD) mainly comprises a timing controller 110, a chamfered circuit 120, a scan driver 130, a data driver 140 and, a display panel 150 as shown in FIG. 1. Wherein, the timing controller 110 is used to generate control signal and transmit the signal to the chamfered circuit 120. The chamfered circuit 120 adjusts the received direct-current voltage according to the control signal and outputs the chamfered voltage. The scan driver 130 is connected to the chamfered circuit 120 in order to transmit the chamfered voltage to the pixel unit of the display panel 150 through scan line. The data driver 24 is use to generate data driving signal under the control of the timing controller 110 and transmit the data driving signal to the pixel unit of the display panel 150 through scan line. Through the above way, the pixel unit is charged and generates the electric field under the control of the scan driver 130 and the data driver 140. Furthermore, it utilizes the changes in the electric field intensity of the liquid crystal molecules to change the orientation of the liquid crystal molecules, which makes the display panel 150 display the picture through controlling the light transmittance of the liquid crystal molecules.

However, in the liquid crystal device according to the prior art, the impedances of the connecting wires between the chamfered circuit 120 and the scan driver 130, and between the timing controller 110 and the scan driver 130 are larger, which causes the adjusted chamfered circuit decay due to the wire impedance when transmitting to the scan driver G1 and G2. Therefore, there is a voltage difference ΔV existed between the scan driving voltage V1 of the scan driver G1 and the scan driving voltage V2 of the scan driver G2 (as shown in FIG. 2), which results the brightness difference existed between the upper half and the bottom half of the picture displayed by the display panel 150, generating the uneven brightness phenomenon on the vertical direction of the display screen.

Therefore, it is necessary to provide a chamfered circuit and a control method thereof to solve the above issue.

### SUMMARY OF THE INVENTION

The technical issue to be solved by the present invention is to provide a chamfered circuit and a control method thereof, in order to eliminate the uneven brightness phenomenon on the vertical direction of the display screen and improve the display quality of the liquid crystal display device.

In order to solve the above issue, a technical solution utilized by the present invention is to provide a chamfered circuit comprising a direct-current voltage input terminal, a chamfered voltage output terminal, a first switching circuit, a second switching circuit, a switching circuit, a first discharge circuit and a second discharge circuit, the first switching circuit being connected between the direct-current voltage input terminal and the chamfered voltage output terminal, the second switching circuit being connected between the chamfered voltage output terminal and the switching circuit, the switching circuit being further connected to the first discharge circuit and the second discharge circuit, the first switching circuit being selectively turned on under the control of a first timing signal in order to selectively transmit the direct-current voltage received by the direct-current voltage input terminal to the chamfered voltage output terminal, the second switching circuit being selectively turned on under the control of a second timing signal, the switching circuit selectively connecting the second switching circuit to the first discharge circuit or the second discharge circuit under the control of a third timing signal in order to make the direct-current voltage transmitted to the chamfered voltage output terminal be discharged in a first discharge slope through the first discharge circuit, further forming a first chamfered voltage, or be discharged in a second discharge slope through the second discharge circuit, further forming a second chamfered voltage, the first discharge slop being different from the second discharge slop; wherein, the switching circuit comprises a voltage comparator, a first transistor and a second transistor, wherein, the first end of the first transistor is connected to the second transistor, the second end of the first transistor is connected to the first discharge circuit, the first end of the second transistor is connected to the second switching circuit, the second end of the second transistor is connected to the second discharge circuit, the control end of the first transistor and the control end of the second transistor are respectively connected to the output terminal of the voltage comparator, the first input terminal of the voltage comparator receives the third timing signal, the second input terminal of the voltage comparator receives a reference voltage, when the third timing signal is higher than the reference voltage, the output terminal of the voltage comparator outputs a first control signal in order to turn on one of the first transistor and the second transistor and turn off the other, when the third timing signal is lower than the reference voltage, the output terminal of the voltage comparator outputs a second control signal in order to turn on one of the first transistor and the second transistor, and turn off the other; the second switching circuit comprises a third transistor and a fourth resistor, the first end of the third transistor is connected to the chamfered voltage output terminal, the second end of the third transistor is connected to the second end of the first transistor and the second end of the second transistor, the control end of the third transistor receives the second timing signal and is connected to a working voltage through the fourth resistor; wherein, the first transistor is a P-type MOSFET, the first end, the second end and the control end of the first transistor respectively are the drain, the source and the gate of the P-type MOSFET, the second transistor is an N-type MOSFET, the first end, the second end and the control end of the second transistor respectively are the drain, the source and the gate of the N-type MOSFET, the third transistor is an N-type MOSFET, the first end, the second end and the control end of the third transistor respectively are the drain, the source and the gate of the N-type MOSFET.

Wherein, the third timing signal is provided to make the voltage comparator output the first control signal in the first half frame time of a frame, and output the second control signal in the second half frame time,

Wherein, the first discharge circuit comprises a first resistor and a second resistor, the second end of the first transistor is connected to the ground though the first resistor and is connected to the working voltage through the second resistor, the second discharge resistor comprises a third resistor, the second end of the second transistor is connected to the ground through the third resistor.

Wherein, the first switching circuit comprises a fourth transistor, a fifth transistor, a fifth resistor, a sixth resistor and a seventh resistor, the first end of the fourth transistor is connected to the direct-current voltage input terminal, the second end of the fourth transistor is connected to the chamfered voltage output terminal, the fifth resistor and the sixth resistor are connected in series between the direct-current voltage input terminal and the first end of the fifth transistor, the control end of the fourth transistor is connected between the fifth resistor and the sixth resistor, the second end of the fifth transistor is connected to the ground, the control end of the fifth transistor is used to receive the first timing signal, the seventh resistor is connected to the control end and the second end of the fifth transistor.

Wherein, the fourth transistor is a P-type MOSFET, the first end, the second end and the control end of the fourth transistor respectively are the source, the drain and the gate of the P-type MOSFET, the fifth transistor is an N-type MOSFET, the first end, the second end and the control end of the fifth transistor respectively are the drain, the source and the gate of the N-type MOSFET.

In order to solve the above issue, another technical solution utilized by the present invention is to provide a chamfered circuit comprising a direct-current voltage input terminal, a chamfered voltage output terminal, a first switching circuit, a second switching circuit, a switching circuit, a first discharge circuit and a second discharge circuit, the first switching circuit being connected between the direct-current voltage input terminal and the chamfered voltage output terminal, the second switching circuit being connected between the chamfered voltage output terminal and the switching circuit, the switching circuit being further connected to the first discharge circuit and the second discharge circuit, the first switching circuit being selectively turned on under the control of a first timing signal in order to selectively transmit the direct-current voltage received by the direct-current voltage input terminal to the chamfered voltage output terminal, the second switching circuit being selectively turned on under the control of a second timing signal, the switching circuit selectively connecting the second switching circuit to the first discharge circuit or the second discharge circuit under the control of a third timing signal in order to make the direct-current voltage transmitted to the chamfered voltage output terminal be discharged in a first discharge slope through the first discharge circuit, further forming a first chamfered voltage, or be discharged in a second discharge slope through the second discharge circuit, further forming a second chamfered voltage, the first discharge slop being different from the second discharge slop.

Wherein, the switching circuit comprises a voltage comparator, a first transistor and a second transistor, wherein, the first end of the first transistor is connected to the second transistor, the second end of the first transistor is connected to the first discharge circuit, the first end of the second transistor is connected to the second switching circuit, the second end of the second transistor is connected to the second discharge circuit, the control end of the first transistor and the control end of the second transistor are respectively connected to the output terminal of the voltage comparator, the first input terminal of the voltage comparator receives the third timing signal, the second input terminal of the voltage comparator receives a reference voltage, when the third timing signal is higher than the reference voltage, the output terminal of the voltage comparator outputs a first control signal in order to turn on one of the first transistor and the second transistor and turn off the other, when the third timing signal is lower than the reference voltage, the output terminal of the voltage comparator outputs a second control signal in order to turn on one of the first transistor and the second transistor, and turn off the other.

Wherein, the third timing signal is provided to make the voltage comparator output the first control signal in the first half frame time of a frame, and output the second control signal in the second half frame time

Wherein, the first discharge circuit comprises a first resistor and a second resistor, the second end of the first transistor is connected to the ground though the first resistor and is connected to the working voltage through the second resistor, the second discharge resistor comprises a third resistor, the second end of the second transistor is connected to the ground through the third resistor.

Wherein, the first transistor is a P-type MOSFET, the first end, the second end and the control end of the first transistor respectively are the drain, the source and the gate of the P-type MOSFET the second transistor is an N-type MOSFET the first end, the second end and the control end of the second transistor respectively are the drain, the source and the gate of the N-type MOSFET.

Wherein, the second switching circuit comprises a third transistor and a fourth resistor, the first end of the third transistor is connected to the chamfered voltage output terminal, the second end of the third transistor is connected to the second end of the first transistor and the second end of the second transistor, the control end of the third transistor receives the second timing signal and is connected to a working voltage through the fourth resistor.

Wherein, the third transistor is an N-type MOSFET, the first end, the second end and the control end of the third transistor respectively are the drain, the source and the gate of the N-type MOSFET.

Wherein, the first switching circuit comprises a fourth transistor, a fifth transistor, a fifth resistor, a sixth resistor and a seventh resistor, the first end of the fourth transistor is connected to the direct-current voltage input terminal, the second end of the fourth transistor is connected to the chamfered voltage output terminal, the fifth resistor and the sixth resistor are connected in series between the direct-current voltage input terminal and the first end of the fifth transistor, the control end of the fourth transistor is connected between the fifth resistor and the sixth resistor, the second end of the fifth transistor is connected to the ground, the control end of the fifth transistor is used to receive the first timing signal, the seventh resistor is connected to the control end and the second end of the fifth transistor.

Wherein, the fourth transistor is a P-type MOSFET, the first end, the second end and the control end of the fourth transistor respectively are the source, the drain and the gate of the P-type MOSFET the fifth transistor is an N-type MOSFET, the first end, the second end and the control end of the fifth transistor respectively are the drain, the source and the gate of the N-type MOSFET.

In order to solve the above technical issue, the other technical solution utilized by the present invention is to provide a control method of chamfered circuit, which comprises: transmitting the direct-current voltage received by a direct-current voltage input terminal to a chamfered voltage output terminal; making the direct-current voltage transmitted to the chamfered voltage output terminal be discharged selectively in a first discharge slope, further forming a first chamfered voltage, or be discharged in a second discharge slope, further forming a second chamfered circuit, the first discharge slop being different from the second discharge slope.

The benefits of the present invention are as follows. The present invention provides a chamfered circuit comprising a direct-current voltage input terminal, a chamfered voltage output terminal, a first switching circuit, a second switching circuit, a switching circuit, a first discharge circuit and a second discharge circuit. Wherein, the switching circuit selectively connects the second switching circuit to the first discharge circuit or the second discharge circuit under the control of a third timing signal in order to form a first chamfered voltage with a first discharge slope or a second chamfered voltage with a second discharge slope at the chamfered voltage output terminal. The first discharge slop is different from the second discharge slope. Therefore, it can decrease the voltage difference in the transmitted driving signal of the display panel, eliminate the uneven brightness phenomenon on the vertical direction of the display screen, and improve the display quality of the liquid crystal display device.

### BRIEF DESCRIPTION OF THE DRAWINGS

FIG. 1 is a schematic view illustrating the structure of the liquid crystal display device according to the prior art;

FIG. 2 is a waveform diagram of the scan driving voltage of the chamfered upper half and bottom half region according to the prior art;

FIG. 3 is a schematic view illustrating the structure of the chamfered circuit according to an embodiment of the present invention;

FIG. 4 is a waveform diagram of each signals received and output by the chamfered circuit according to the present invention;

FIG. 5 is a flow chart of the control method of the chamfered circuit according to an embodiment of the present invention.

### DETAILED DESCRIPTION OF THE PREFERRED EMBODIMENTS

The detailed descriptions accompanying drawings and the embodiment of the present invention are as follows.

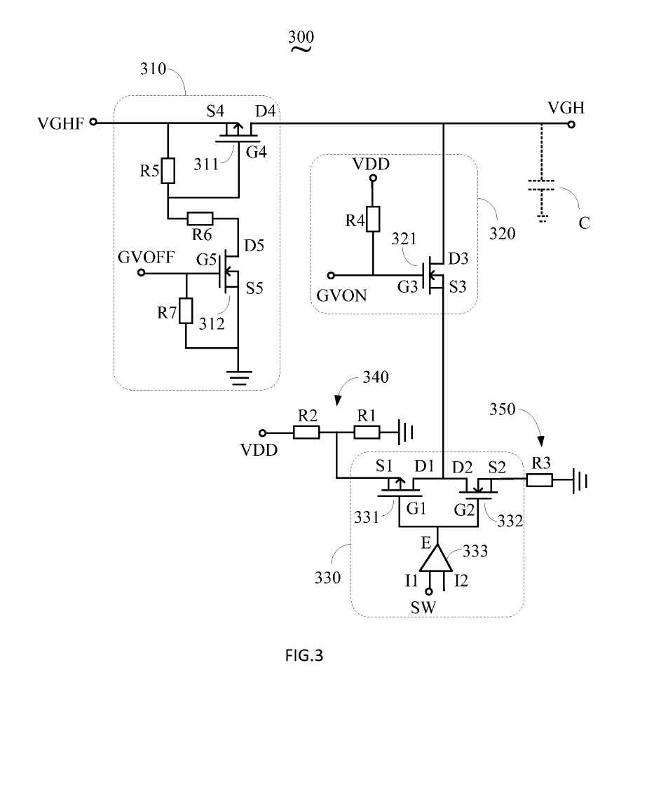

FIG. 3 is a schematic view illustrating the structure of the chamfered circuit according to an embodiment of the present invention. As shown in FIG. 3, the chamfered circuit 300 comprises a direct-current voltage input terminal VGHF, a chamfered voltage output terminal VGH, a first switching circuit 310, a second switching circuit 320, a switching circuit 330, a first discharge circuit 340 and a second discharge circuit 350. Wherein, the first switching circuit 310 is connected between the direct-current voltage input terminal VGHF and the chamfered voltage output terminal VGH, which is selectively turned on under the control of the first timing signal GVOFF output by the timing controller, and selectively transmits the direct-current voltage received by the direct-current voltage input terminal VGHF to the chamfered voltage output terminal VGH.

The second switching circuit 320 is connected between the chamfered voltage output terminal VGH and the switching circuit 330, which is selectively turned on under the control of the second timing signal GVON output by the timing controller.

The switching circuit 330 is connected to the first discharge circuit 340 and the second discharge circuit 350 in order to selectively connect the second switching circuit 320 to the first discharge circuit 340 or the second discharge circuit 350 under the control of the third timing signal SW output by the timing controller, which makes the transmitted direct-current voltage of the chamfered voltage output terminal VGH be discharged in a first discharge slope through the first discharge circuit 340, further forming a first chamfered voltage, or discharged in a second discharge slope through the second discharge circuit 350, further forming a second chamfered circuit. The first discharge slop is different from the second discharge slop.

The switching circuit 330 comprises a first transistor 331, a second transistor 332 and a voltage comparator 333. Wherein, the first end D1 of the first transistor 331 is connected to the second switching circuit 320, the second end S1 of the first transistor 331 is connected to the first discharge circuit 340, the first end D2 of the second transistor 332 is connected to the second switching circuit 320, the second end S2 of the second transistor 332 is connected to the second discharge circuit 350, the control end G1 of the first transistor 331 and the control end G2 of the second transistor 332 are respectively connected to the output terminal E of the voltage comparator 333. The first input terminal 11 of the voltage comparator 333 is used to receive the third timing signal SW output by the timing controller, the second input terminal I2 of the voltage comparator 333 is used to receive the reference voltage. When the third timing signal SW is higher than the reference voltage, the output terminal E of the voltage comparator 333 outputs a first control signal in order to turn on one of the first transistor 331 and the second transistor 332 and turn off the other. When the third timing signal SW is lower than the reference voltage, the output terminal E of the voltage comparator 333 outputs a second control signal in order to turn on one of the first transistor 331 and the second transistor 332 and turn off the other.

The first discharge circuit 340 comprises a first resistor R1 and a second resistor R2. The second discharge resistor 350 comprises a third resistor R3. Wherein, the second end S1 of the first transistor 331 is connected to the ground though the first resistor R1 and is connected to the working voltage VDD through the second resistor R2. The second end S2 of the second transistor 332 is connected to the ground through the third resistor R3. In the present embodiment, the first transistor 331 is a P-type MOSFET, the first end D1, the second S1 end and the control end G1 of the first transistor 331 respectively are the drain, the source and the gate of the P-type MOSFET The second transistor 332 is an N-type MOSFET, the first end D2, the second end S2 and the control end G2 of the second transistor 332 respectively are the drain, the source and the gate of the N-type MOSFET. It should be understood that, in the other embodiments, it can also utilize other simply components with switching function to design the circuit, such as transistor, silicon controlled rectifier, relay, etc., and is not limited in the P/N type MOSFET according to the present embodiment.

Referring to FIG. 2 again, the second switching circuit 320 comprises a third transistor 321 and a fourth resistor R4. Wherein, the first end D3 of the third transistor 321 is connected to the chamfered voltage output terminal VGH. The second end S3 of the third transistor 321 is connected to both the first end D1 of the first transistor 331 and the first end D2 of the second transistor 332. The control end G3 of the third transistor 321 receives the second timing signal GVON output by the timing controller and is connected to the working voltage VDD through the fourth resistor R4. In the present embodiment, the third transistor 321 is an N-type MOSFET, the first end 03, the second S3 end and the control end G3 of the third transistor 321 respectively are the drain, the source and the gate of the N-type MOSFET.

The first switching circuit 310 comprises a fourth transistor 311, a fifth transistor 312, a fifth resistor R5, a sixth resistor R6, and a seventh resistor R7. Wherein, the first end S4 of the fourth transistor 311 is connected to the direct-current voltage input terminal VGHF. The second end D4 of the fourth transistor 311 is connected to the chamfered voltage output terminal VGH. The fifth resistor R5 and the sixth resistor R6 are connected in series between the direct-current voltage input terminal VGHF and the first end D5 of the fifth transistor 312. The control end G4 of the fourth transistor 311 is connected between the fifth resistor R5 and the sixth resistor R6. The second end S5 of the fifth transistor 312 is connected to the ground. The control end G5 of the fifth transistor 312 is used to receive the first timing signal GVOFF. The seventh resistor R7 is connected to the control end G5 and the second end S5 of the fifth transistor 312. In the present embodiment, the fourth transistor 311 is a P-type MOSFET, and the first end 54, the second end D4 and the control end G4 thereof respectively are the source, the drain and the gate of the P-type MOSFET The fifth transistor 312 is an N-type MOSFET, and the first end D5, the second end S5 and the control end G5 thereof respectively are the drain, the source and the gate of the N-type MOSFET.

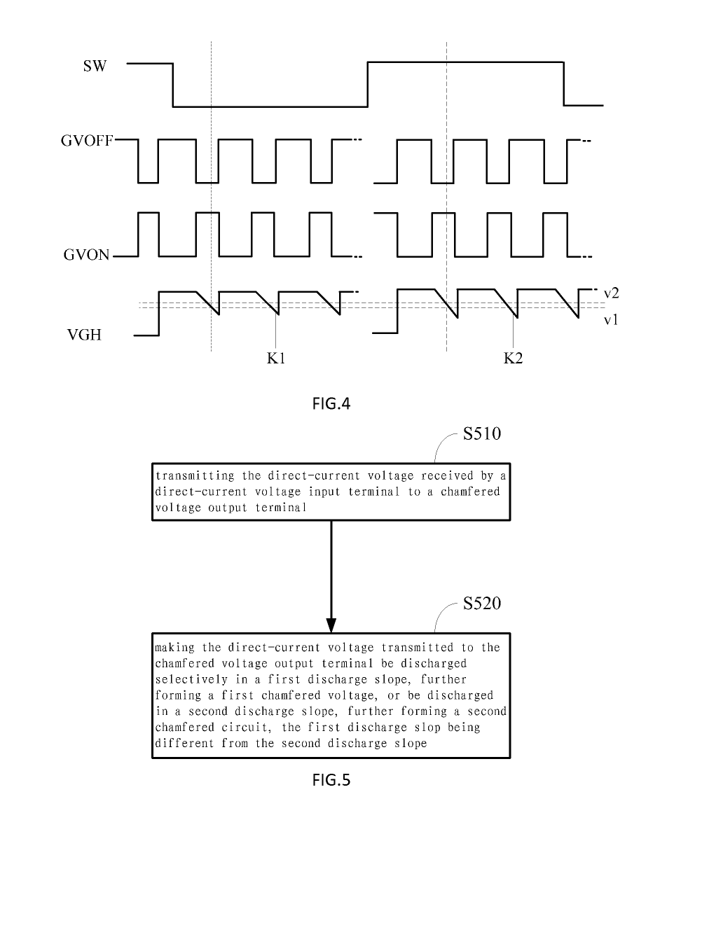

FIG. 4 is a waveform diagram of each signals received and output by the chamfered circuit according to the present invention. The operation principle of the chamfered circuit 300 will be described in detail accompanying with FIG. 3 and FIG. 4 as follows.

The control end G5 of the fifth transistor 312 is used to receive the first timing signal GVOFF, and the control end G3 of the third transistor 321 receives the second timing signal GVON. Wherein, the first timing signal GVOFF and the second timing signal GVON are mutually inverted signal and both are voltage signal.

When the first timing signal GVOFF is under high level, the fourth transistor 311 and the fifth transistor 312 are turned on. At this time, the second timing signal GVON is under low level, the third transistor 321 is turned off. When the second timing signal GVON is under high level, the third transistor 321 is turned on. The first timing signal GVOFF is under low level, the fourth transistor 311 and the fifth transistor 312 are turned off. At this time, the capacitor C is discharged to form the chamfered voltage and output to the chamfered voltage output terminal VGH. Of course, the capacitor C is not necessary. It can generate the chamfered voltage through controlling the corresponding relationship between the first timing signal GVOFF and the second timing signal GVON.

Correspondingly, the first input terminal 11 of the voltage comparator 333 receives the third timing signal SW output by the timing controller. For example, in the first half frame time of a frame, the third timing signal SW is lower than the reference voltage received by the second input terminal 12 of the voltage comparator 333. Then, the output terminal E of the comparator 333 outputs the first control signal, which turns on the second transistor 332 and turns off the first transistor 331. At this time, the second switching circuit 320 is selectively connected to the second discharge circuit 350, which means to form the first chamfered voltage with a first discharge slope K1 through the discharge of the third resistor R3.

In the second half frame time of a frame, the third timing signal SW is higher than the reference voltage. The output terminal E of the voltage comparator 333 outputs the second control signal to turn on the first transistor 331 and turn off the second transistor 332. At this time, the second switching circuit 320 is selectively connected to the first discharge circuit 340, which means to form the second chamfered voltage with a second discharge slope K2 through the discharge of the first resistor R1.

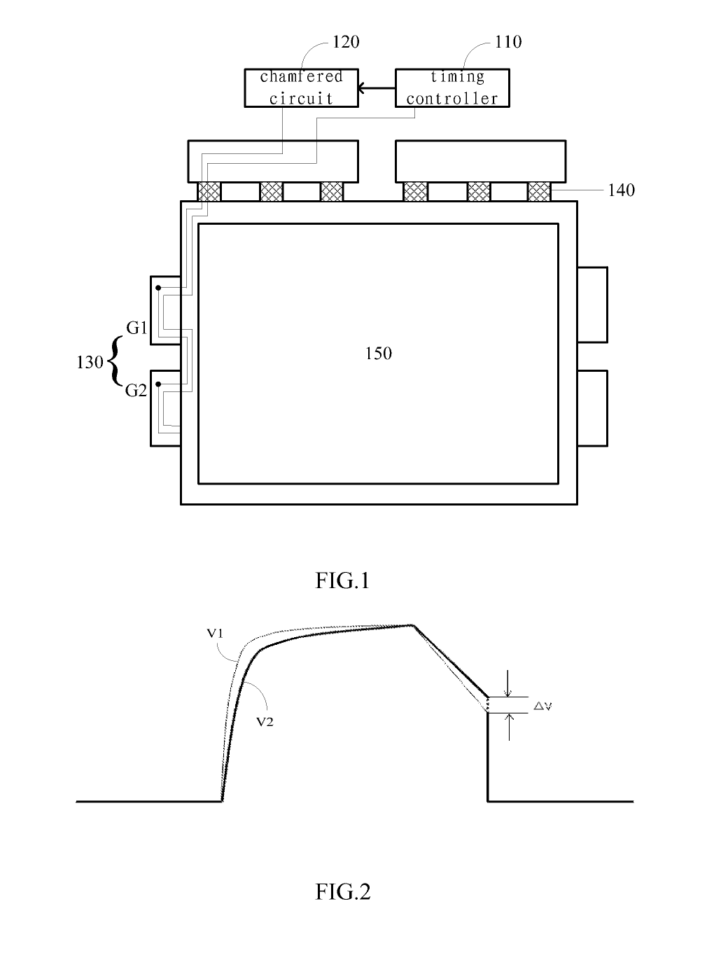

Base on above description, it only needs to provide the first resistor R1 and the third resistor R3 according to the actual requirement, accordingly forming the first discharge slope K1 and second discharge slope K2 through the discharge, which makes both the first discharge slope K1 and the second discharge slope K2 as equal as possible. That is, make the voltage difference ΔV between the scan driving voltage V1 of the scan driver G1 and the scan driving voltage V2 of the scan driver G2 as shown in FIG. 1 approaches zero. Thereby, it can reduce the voltage difference of the driving signals transmitted to the display panel, eliminate the uneven brightness phenomenon on the vertical direction of the display screen, and improve the display quality of the liquid crystal display device.

In the present embodiment, it should be noted that the third timing signal SW output by the timing controller must be provided to make the voltage comparator 333 output the first control signal in the first half frame time of a frame and output the second control signal in the second half frame time.

FIG. 5 is a flow chart of the control method of the chamfered circuit according to an embodiment of the present invention. As shown in FIG. 5, the steps of the control method of the chamfered circuit in the present embodiment mainly comprises:

step 5510: transmitting the direct-current voltage received by a direct-current voltage input terminal to a chamfered voltage output terminal:

step S520: making the direct-current voltage transmitted to the chamfered voltage output terminal be discharged selectively in a first discharge slope, further forming a first chamfered voltage, or be discharged in a second discharge slope, further forming a second chamfered circuit, the first discharge slop being different from the second discharge slope.

Wherein, the process of selectively discharged in the first discharge slope or the second discharge slope and forming the corresponding first chamfered voltage or second chamfered voltage is the same as the operation principle of the chamfered circuit 300 mentioned above, which is not repeated here.

The preferred embodiments according to the present invention are mentioned above, which cannot be used to define the scope of the right of the present invention. Those modifications and variations are considered encompassed in the scope of protection defined by the clams of the present invention.

What is claimed is:

1. A chamfered circuit, comprising a direct-current voltage input terminal, a chamfered voltage output terminal, a first switching circuit, a second switching circuit, a switching circuit, a first discharge circuit and a second discharge circuit, the first switching circuit being connected between the direct-current voltage input terminal and the chamfered voltage output terminal, the second switching circuit being connected between the chamfered voltage output terminal and the switching circuit, the switching circuit being further connected to the first discharge circuit and the second discharge circuit, the first switching circuit being selectively turned on under the control of a first timing signal in order to selectively transmit the direct-current voltage received by the direct-current voltage input terminal to the chamfered voltage output terminal, the second switching circuit being selectively turned on under the control of a second timing signal, the switching circuit selectively connecting the second switching circuit to the first discharge circuit or the second discharge circuit under the control of a third timing signal in order to make the direct-current voltage transmitted to the chamfered voltage output terminal be discharged in a first discharge slope through the first discharge circuit, further forming a first chamfered voltage, or be discharged in a second discharge slope through the second discharge circuit, further forming a second chamfered voltage, the first discharge slop being different from the second discharge slop;
wherein, the switching circuit comprises a voltage comparator, a first transistor and a second transistor, wherein, the first end of the first transistor is connected to the second transistor, the second end of the first transistor is connected to the first discharge circuit, the first end of the second transistor is connected to the second switching circuit, the second end of the second transistor is connected to the second discharge circuit, the control end of the first transistor and the control end of the second transistor are respectively connected to the output terminal of the voltage comparator, the first input terminal of the voltage comparator receives the third timing signal, the second input terminal of the voltage comparator receives a reference voltage, when the third timing signal is higher than the reference voltage, the output terminal of the voltage comparator outputs a first control signal in order to turn on one of the first transistor and the second transistor and turn off the other, when the third timing signal is lower than the reference voltage, the output terminal of the voltage comparator outputs a second control signal in order to turn on one of the first transistor and the second transistor, and turn off the other; the second switching circuit comprises a third transistor and a fourth resistor, the first end of the third transistor is connected to the chamfered voltage output terminal, the second end of the third transistor is connected to the second end of the first transistor and the second end of the second transistor, the control end of the third transistor receives the second timing signal and is connected to a working voltage through the fourth resistor, wherein, the first transistor is a P-type MOSFET, the first end, the second end and the control end of the first transistor respectively are the drain, the source and the gate of the P-type MOSFET the second transistor is an N-type MOSFET, the first end, the second end and the control end of the second transistor respectively are the drain, the source and the gate of the N-type MOSFET, the third transistor is an N-type MOSFET the first end, the second end and the control end of the third transistor respectively are the drain, the source and the gate of the N-type MOSFET.

2. The chamfered circuit as claimed in claim 1, wherein, the third timing signal is provided to make the voltage comparator output the first control signal in the first half frame time of a frame, and output the second control signal in the second half frame time.

3. The chamfered circuit as claimed in claim 1, wherein, the first discharge circuit comprises a first resistor and a second resistor, the second end of the first transistor is connected to the ground though the first resistor and is connected to the working voltage through the second resistor, the second discharge resistor comprises a third resistor, the second end of the second transistor is connected to the ground through the third resistor.

4. The chamfered circuit as claimed in claim 1, wherein, the first switching circuit comprises a fourth transistor, a fifth transistor, a fifth resistor, a sixth resistor and a seventh resistor, the first end of the fourth transistor is connected to the direct-current voltage input terminal, the second end of the fourth transistor is connected to the chamfered voltage output terminal, the fifth resistor and the sixth resistor are connected in series between the direct-current voltage input terminal and the first end of the fifth transistor, the control end of the fourth transistor is connected between the fifth resistor and the sixth resistor, the second end of the fifth transistor is connected to the ground, the control end of the fifth transistor is used to receive the first timing signal, the seventh resistor is connected to the control end and the second end of the fifth transistor.

5. The chamfered circuit as claimed in claim 1, wherein, the fourth transistor is a P-type MOSFET, the first end, the second end and the control end of the fourth transistor respectively are the source, the drain and the gate of the P-type MOSFET, the fifth transistor is an N-type MOSFET, the first end, the second end and the control end of the fifth transistor respectively are the drain, the source and the gate of the N-type MOSFET.

6. A chamfered circuit, comprising a direct-current voltage input terminal, a chamfered voltage output terminal, a first switching circuit, a second switching circuit, a switching circuit, a first discharge circuit and a second discharge circuit, the first switching circuit being connected between the direct-current voltage input terminal and the chamfered voltage output terminal, the second switching circuit being connected between the chamfered voltage output terminal and the switching circuit, the switching circuit being further connected to the first discharge circuit and the second discharge circuit, the first switching circuit being selectively turned on under the control of a first timing signal in order to selectively transmit the direct-current voltage received by the direct-current voltage input terminal to the chamfered voltage output terminal, the second switching circuit being selectively turned on under the control of a second timing signal, the switching circuit selectively connecting the second switching circuit to the first discharge circuit or the second discharge circuit under the control of a third timing signal in order to make the direct-current voltage transmitted to the chamfered voltage output terminal be discharged in a first discharge slope through the first discharge circuit, further forming a first chamfered voltage, or be discharged in a second discharge slope through the second discharge circuit, further forming a second chamfered voltage, the first discharge slop being different from the second discharge slop.

7. The chamfered circuit as claimed in claim 6, wherein, the switching circuit comprises a voltage comparator, a first transistor and a second transistor, wherein, the first end of the first transistor is connected to the second transistor, the second end of the first transistor is connected to the first discharge circuit, the first end of the second transistor is connected to the second switching circuit, the second end of the second transistor is connected to the second discharge circuit, the control, end of the first transistor and the control end of the second transistor are respectively connected to the output terminal of the voltage comparator, the first input terminal of the voltage comparator receives the third timing signal, the second input terminal of the voltage comparator receives a reference voltage, when the third timing signal is higher than the reference voltage, the output terminal of the voltage comparator outputs a first control signal in order to turn on one of the first transistor and the second transistor and turn off the other, when the third timing signal is lower than the reference voltage, the output terminal of the voltage comparator outputs a second control signal in order to turn on one of the first transistor and the second transistor, and turn off the other.

8. The chamfered circuit as claimed in claim 7, wherein, the third timing signal is provided to make the voltage comparator output the first control signal in the first half frame time of a frame, and output the second control signal in the second half frame time.

9. The chamfered circuit as claimed in claim 7, wherein, the first discharge circuit comprises a first resistor and a second resistor, the second end of the first transistor is connected to the ground though the first resistor and is connected to the working voltage through the second resistor, the second discharge resistor comprises a third resistor, the second end of the second transistor is connected to the ground through the third resistor.

10. The chamfered circuit as claimed in claim 9, wherein, the first transistor is a P-type MOSFET, the first end, the second end and the control end of the first transistor respectively are the drain, the source and the gate of the P-type MOSFET, the second transistor is an N-type MOSFET, the first end, the second end and the control end of the second transistor respectively are the drain, the source and the gate of the N-type MOSFET.

11. The chamfered circuit as claimed in claim 9, wherein, the second switching circuit comprises a third transistor and a fourth resistor, the first end of the third transistor is connected to the chamfered voltage output terminal, the second end of the third transistor is connected to the second end of the first transistor and the second end of the second transistor, the control end of the third transistor receives the second timing signal and is connected to a working voltage through the fourth resistor.

12. The chamfered circuit as claimed in claim 11, wherein, the third transistor is an N-type MOSFET, the first end, the second end and the control end of the third transistor respectively are the drain, the source and the gate of the N-type MOSFET.

13. The chamfered circuit as claimed in claim 11, wherein, the first switching circuit comprises a fourth transistor, a fifth transistor, a fifth resistor, a sixth resistor and a seventh resistor, the first end of the fourth transistor is connected to the direct-current voltage input terminal, the second end of the fourth transistor is connected to the chamfered voltage output terminal, the fifth resistor and the sixth resistor are connected in series between the direct-current voltage input terminal and the first end of the fifth transistor, the control end of the fourth transistor is connected between the fifth resistor and the sixth resistor, the second end of the fifth transistor is connected to the ground, the control end of the fifth transistor is used to receive the first timing signal, the seventh resistor is connected to the control end and the second end of the fifth transistor.

14. The chamfered circuit as claimed in claim 11, wherein, the fourth transistor is a P-type MOSFET, the first end, the second end and the control end of the fourth transistor respectively are the source, the drain and the gate of the P-type MOSFET, the fifth transistor is an N-type MOSFET, the first end, the second end and the control end of the fifth transistor respectively are the drain, the source and, the gate of the N-type MOSFET.

15. A control method of chamfered circuit, comprising:
transmitting the direct-current voltage received by a direct-current voltage input terminal to a chamfered voltage output terminal;
making the direct-current voltage transmitted to the chamfered voltage output terminal be discharged selectively in a first discharge slope, further forming a first chamfered voltage, or be discharged in a second discharge slope, further forming a second chamfered circuit, the first discharge slop being different from the second discharge slope.
